(19) United States
(12) Patent Application Publication
(10) Pub. No.: US 2009/0184646 A1
(43) Pub. Date: Jul. 23, 2009

(54) LIGHT EMITTING DIODE CAP LAMP

(76) Inventors: JOHN DEVANEY, Mountain Top, PA (US); John Kosek, Bear Creek Township, PA (US)

Correspondence Address: PATENT GROUP;C/O DLA PIPER US LLP, 203 N. LASALLE ST., SUITE 1900, CHICAGO, IL, 60601, US

(21) Appl. No.: 12/340,148

(22) Filed: Dec. 19, 2008

Related U.S. Application Data
(60) Provisional application No. 61/008,695, filed on Dec. 21, 2007.

(51) Int. Cl. H01J 13/32; F21L 4/00; H05B 39/06; H05B 41/36; H01J 9/24

(52) U.S. Cl. 315/113; 362/190; 362/191; 315/313; 315/294; 445/23

(57) ABSTRACT

A cap lamp features a housing. A control module is positioned within the housing and includes a multi-function switch, a circuit board and contacts adapted to receive power from a battery. An optic module is also positioned within the housing and in engagement with the control module. The optic module includes a light emitting diode (LED) module and an integrated reflector and heat sink as well as an insulator. A bezel is fastened to the housing so as to secure the control module and optic module within the cap lamp housing. A pushbutton is positioned on the housing and is connected to the multi-function switch. A backup LED is in communication with the multi-function switch so that the main LED light or the backup LED may alternatively be selected.

### CLAIM OF PRIORITY

This application claims priority from U.S. Provisional Patent Application Ser. No. 61/008,695, filed Dec. 21, 2007, currently pending.

### FIELD OF THE INVENTION

The present invention relates to cap lamps and other portable light sources and, more particularly, to a battery-powered cap lamp featuring a light emitting diode light source.

### BACKGROUND

Cap lamps are typically mounted on hard hats worm by miners to provide illumination in underground mine shafts. Such cap lamps are well known in the mining equipment industry and provide illumination while the miner's hands remain free to perform tasks. Cap lamps may also be used by rescue workers or in other occupations where individuals must see in low visibility environments and have both hands available for tasks.

A cap lamp typically receives power from a battery power pack secured to the user's waist. An electrical power cord delivers power from the power pack to the lamp on the helmet. Cap lamps typically use conventional incandescent bulbs as a light source. Recently, cap lamps that use light emitting diodes (LEDs) as light sources have been developed. Such cap lamps typically provide superior lighting when compared to incandescent light bulbs.

### BRIEF DESCRIPTION OF THE DRAWINGS

FIG. 1 is a front perspective view of an embodiment of the light emitting diode (LED) cap lamp of the present invention;

FIG. 2 is a rear perspective view of the LED cap lamp of FIG. 1;

FIG. 3 is a front elevational view of the LED cap lamp of FIGS. 1 and 2;

FIG. 4 is a sectional view of the LED cap lamp of FIGS. 1-3 taken along line 4-4 of FIG. 3;

FIG. 5 is an exploded rear perspective view of the LED cap lamp of FIGS. 1-4;

FIG. 6 is an enlarged, exploded front perspective view of an embodiment of the optic module of the LED cap lamp of FIGS. 1-5;

FIG. 7 is a front perspective view of the optic module of FIG. 6 in an assembled condition;

FIG. 8 is a top plan view of the assembled optic module of FIG. 7;

FIG. 9 is a sectional view of the assembled optic module of FIGS. 7 and 8 taken along line 9-9 of FIG. 8;

FIG. 10 is an enlarged perspective view of the control module of the LED cap lamp of FIGS. 1-5;

FIG. 11 is a schematic of a first embodiment of the circuit board of FIG. 10;

FIG. 12 is a schematic of a second embodiment of the circuit board of FIG. 10;

FIG. 13 is an enlarged, exploded front perspective view of a the optic module of the LED cap lamp of FIGS. 1-5 with the addition of an interchangeable optic lens;

FIG. 14 is a front perspective view of the optic module and optic lens of FIG. 13 in an assembled condition;

FIG. 15 is a top plan view of the assembled optic module and optic lens of FIG. 14;

FIG. 16 is a sectional view of the assembled optic module and optic lens of FIGS. 14 and 15 taken along line 16-16 of FIG. 15;

FIG. 17 is a perspective view of a second embodiment of the LED cap lamp of the present invention;

FIG. 18 is a top plan view of the LED cap lamp of FIG. 17;

FIG. 19 is a sectional view of the cap lamp of FIGS. 17 and 18 taken along line 19-19 of FIG. 18.

### DETAILED DESCRIPTION OF EMBODIMENTS

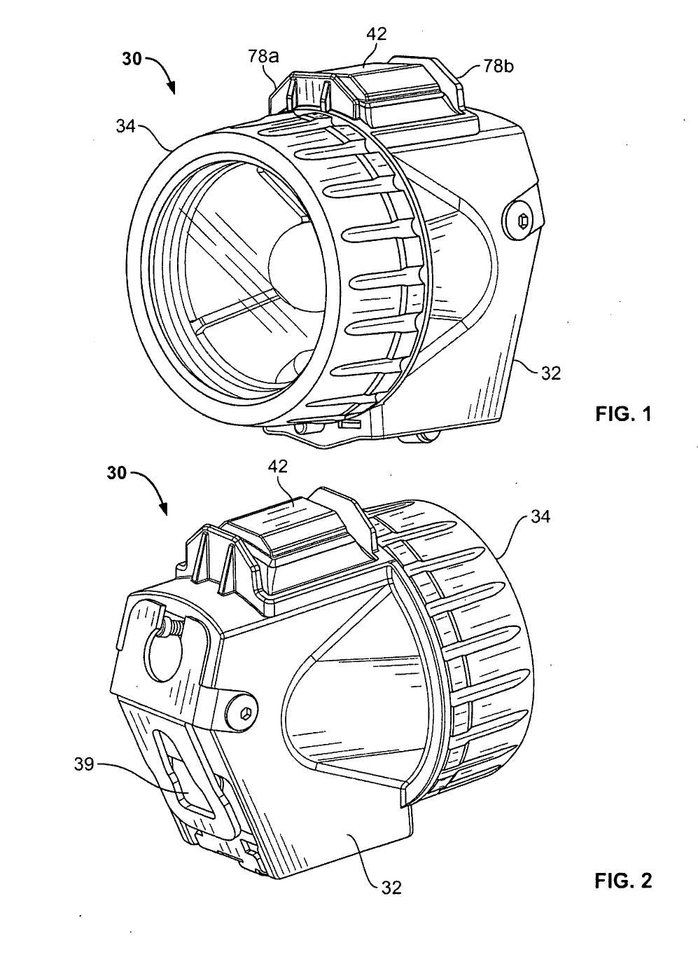

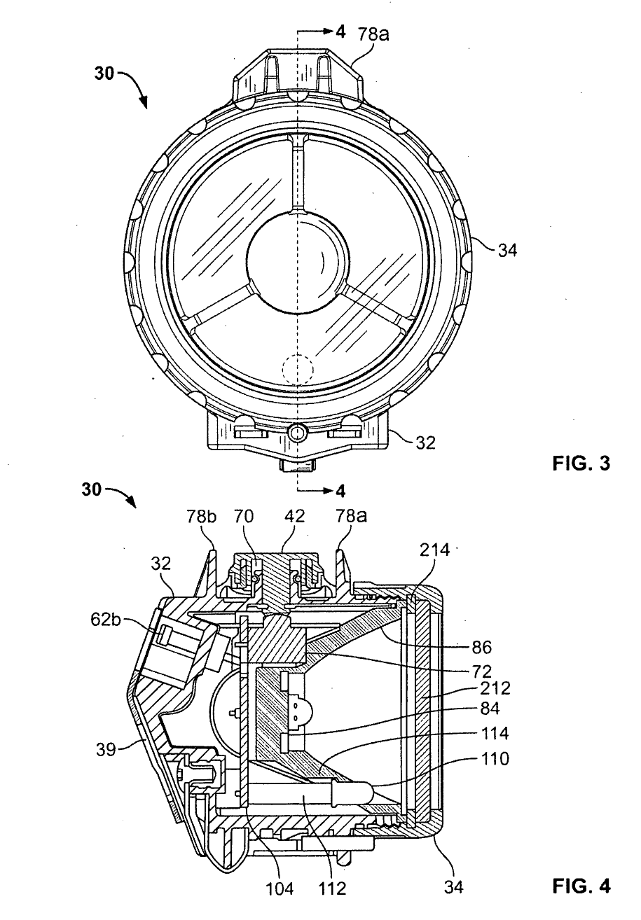

An embodiment of the light emitting diode (LED) cap lamp of the present invention is indicated in general at 30 in FIGS. 1-4. While the invention is described below in terms of use with a helmet and cap lamp for mining, it is to be understood that it may be applied to other types of head gear and portable lighting.

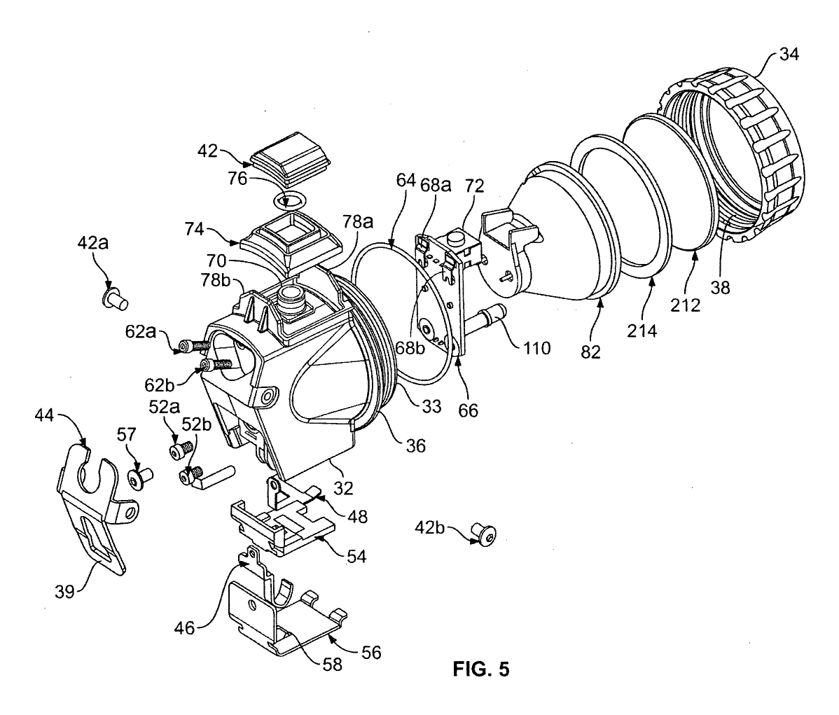

The cap lamp 30 features a housing 32 having an open end 33 (FIG. 5) to which a bezel 34 is mounted via threads, illustrated at 36 and 38 in FIG. 5. While threads are illustrated, other fastening arrangements known in the art, such as a hinge and catch arrangement, screws or other fasteners, tab or pin and notch arrangements, may be alternatively used. Both the housing and bezel preferably are molded from plastic. As will be explained in greater detail below, a pushbutton, illustrated at 42 in FIGS. 1, 2 and 4, is mounted on the top of housing 32 and controls operation of the cap lamp.

As illustrated in FIGS. 2 and 4, the cap lamp features a clip 39 designed to attach the cap lamp to a standard mining helmet. As a result, the cap lamp easily clips onto standard helmet mounting attachments. With reference to FIG. 5, the clip 39 is attached to the cap lamp housing 32 by fasteners 42a and 42b. The clip features an opening 44 through which the cap lamp power cord (not shown) passes.

As illustrated in FIG. 5, positive recharging contact 46 and a negative recharging contact 48 are secured within the lower portion of the cap lamp housing 32 by screws 52a and 52b. An insulator plate 54 is inserted into the lower portion of the housing so as to substantially cover the recharging contacts and a cover plate 56 is secured to the bottom of the housing via fastener 57 to cover the insulator plate. The cover plate features an opening 58 through which a J-shaped portion of the positive recharging contact 46 protrudes so that it may be engaged by a battery recharging rack. In addition, a slot is formed between the cover plate 56 and the bottom of the housing 32 so that a tab of the battery recharging rack may engage negative recharging contact plate 48. The positive and negative recharging contacts electrically communicate with screws 62a and 62b, which are used attach the power cord to the cap lamp. The opposite end of the power cord is attached to a battery power source, such as the WHEAT LI-16 battery from Koehlier-Bright Star, Inc. of Hanover Township, Pennsylvania. As a result, the battery is recharged when the cap lamp is placed in the recharging rack. A variety of alternative configurations may be used for the positive and negative recharging contacts to accommodate a variety of specific charging rack types from a variety of manufacturers.

As further illustrated in FIG. 5, an O-ring 64 is positioned over the threads 36 of the threaded portion of the housing so as to be trapped between the bezel 34 and the housing 32 after assembly of the cap lamp, thus forming a seal.

With reference to FIG. 5, a control module 66 is positioned within the housing 32 and, as explained in greater detail below, controls operation of the cap lamp. The control module features positive and negative contacts 68a and 68b which are engaged by screws 62a and 62b. As described previously, the screws 62a and 62b are connected to, and receive power from, a power cord that is connected to a battery so that the control module receives power.

Again referring to FIG. 5 (and with reference to FIG. 4), the top mounted pushbutton 42 engages a plunger button 70, which in turn engages a multi-function switch 72, which is part of the control module 66. Pushbutton 42 is easily operated with a gloved hand compared to lever or slide type switches. The pushbutton and switch assembly features a dual seal design combining an outer diaphragm gasket 74, which seals around the periphery of pushbutton 42, and an inner O-ring seal 76, which seals around plunger button 70, to reliably prevent moisture and contaminant ingress into the housing. The outer diaphragm gasket also acts like a spring/shock absorber to protect the switch when exposed to impact loads increasing ruggedness and provides the force necessary to overcome the friction imparted by the o-ring seal. Front and rear pushbutton guards 78a and 78b, respectively, prevent accidental operation of the pushbutton 42.

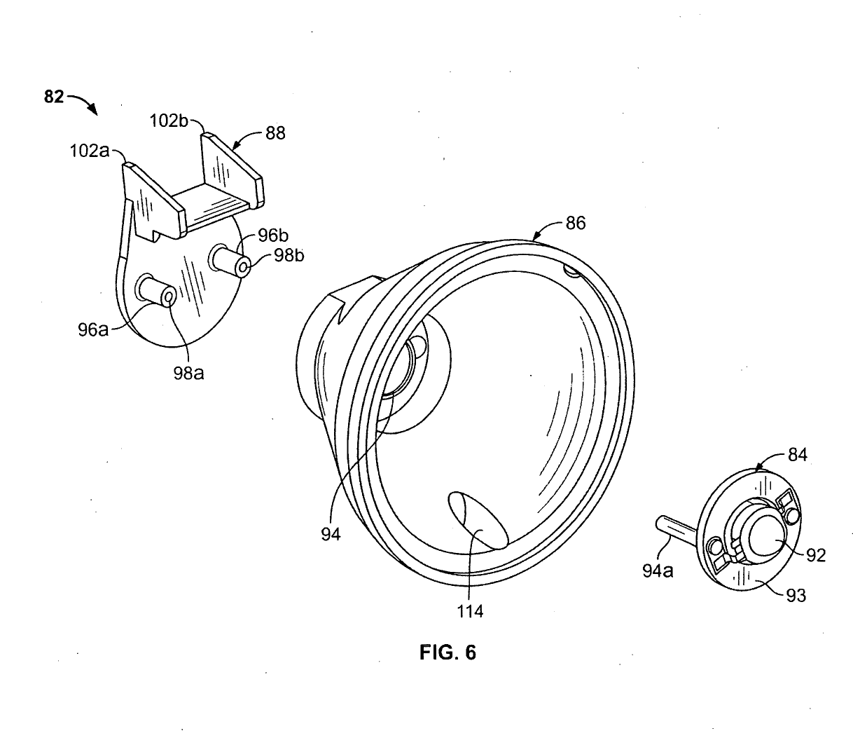

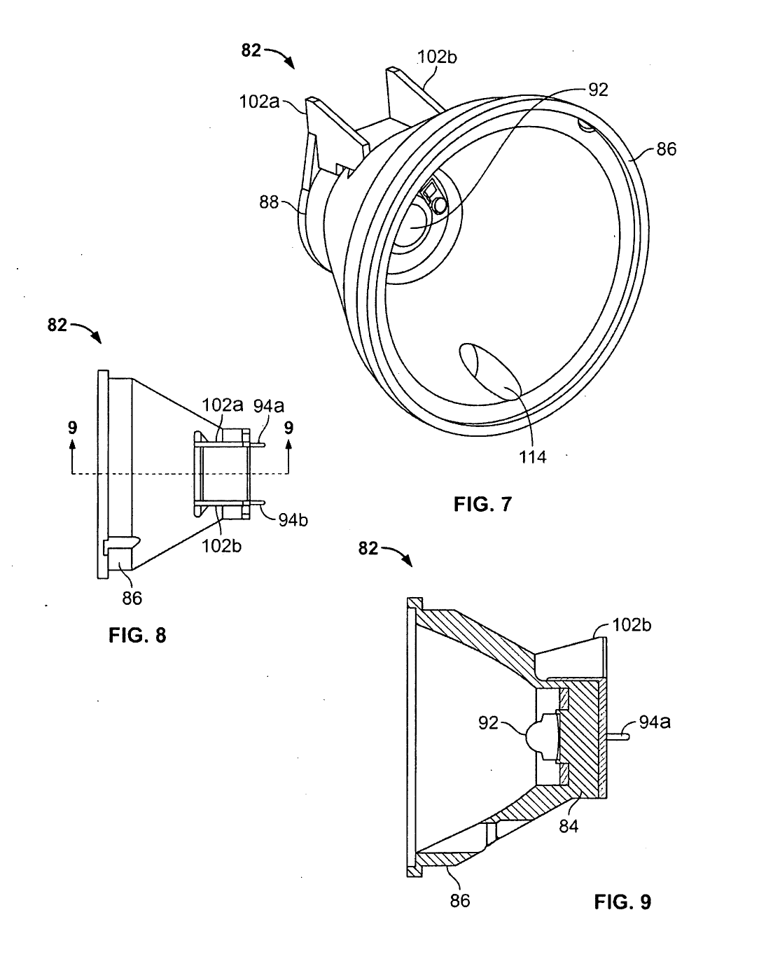

An optic module, indicated in general at 82 in FIGS. 5-9, is also positioned within the cap lamp housing 32 and, as explained in greater detail below, electrically engages control module 66. As illustrated in FIG. 6, the optic module includes an LED module 84, an integrated reflector and heat sink 86 and an insulator 88. The LED module 84 includes a high-brightness LED main light 92, a disk-shaped LED socket board 93 and, as illustrated in FIGS. 6, 8 and 9, leads 94a and 94b through which power may be provided to the LED main light. As illustrated in FIGS. 6-9, the LED module 84 is positioned within the central opening 94 of the integrated reflector and heat sink 86. The integrated reflector and heat sink 86 preferably is constructed out of a material, such as aluminum, that allows it to serve as a heat sink for the LED module 84. As illustrated in FIGS. 6-9, the insulator 88, preferably constructed from thermoplastic, is attached to the rear of the integrated reflector and heat sink 86. As illustrated in FIG. 6, the insulator 88 features bosses 96a and 96b having bores 98a and 98b, respectively, through which the leads 94a and 94b of the LED module pass. The insulator 88 serves to electrically isolate the integrated reflector and heat sink 86 from the control module (66 of FIG. 5) and reduces heat transfer between the two. As illustrated in FIGS. 6-9, the insulator 88 features an opposing pair of fins 102a and 102b which define a space there between for receiving the switch (72 in FIG. 5) of the control module.

High-brightness LEDs require an efficient way to remove heat generated in the diode. The integrated heat sink and reflector 86 functions efficiently by utilizing the increased surface area of the reflector geometry to dissipate heat. This design also reduces the number of components so as to reduce costs and simplify assembly.

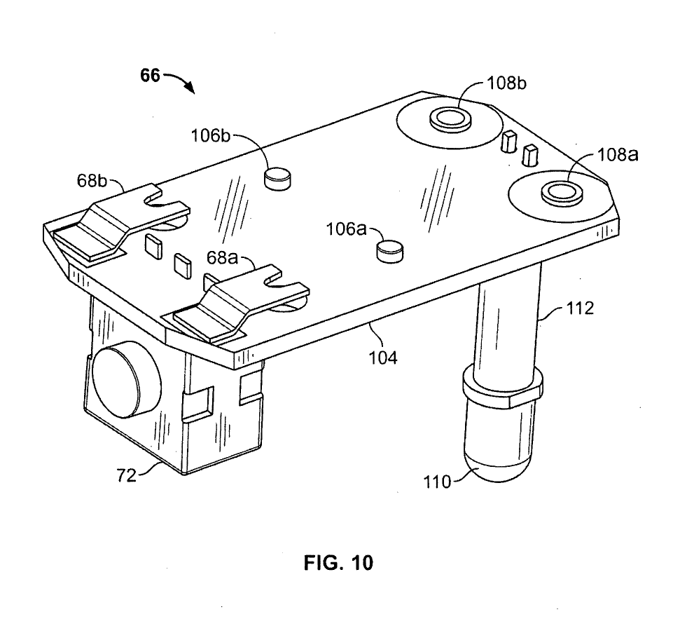

The control module is indicated in general at 66 in FIGS. 5 and 10. As illustrated in FIG. 10, the control module features a printed circuit board 104, a multi-function switch 72, contacts 68a and 68b, LED module sockets 106a and 106b and backup LED sockets 108a and 108b. The LED module 84 leads 94a and 94b (FIGS. 6, 8 and 9) engage the LED module sockets 106a and 106b.

A backup LED 110 is mounted on a standoff 112, which is preferably constructed of plastic and mounted to the printed circuit board 104. The backup LED 110 has leads that engage the backup LED sockets 108a and 108b. The backup LED 110 is positioned within a recess formed in the integrated reflector and heat sink, illustrated at 114 in FIGS. 4, 6 and 7.

The multi-function switch, indicated at 72 in FIGS. 4, 5 and 10, is used to select the main high-brightness LED (92 in FIGS. 6, 7 and 9) or the standard backup LED (110 in FIGS. 4, 5 and 10) or off. As described previously, the switch 72 is manipulated by a user via pushbutton 42 of FIGS. 1, 2, 4 and 5.

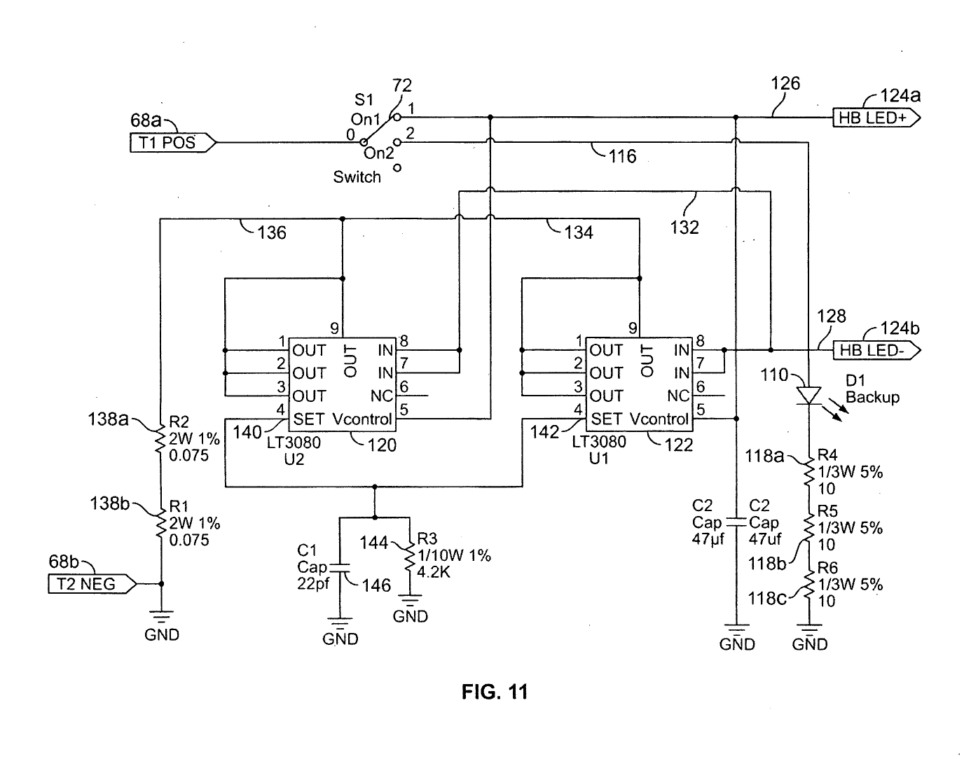

A schematic of an embodiment of the circuitry of the printed circuit board 104 of the control module 66 of FIG. 10 is illustrated in FIG. 11. The positive contact 68a of the control module is connected to multi-function switch 72 while the negative contact 68b is connected to ground. When switch 72 is configured to provide power to the backup LED, current flows through line 116 to the backup LED 110. Current exiting the backup LED flows through resistors 118a, 18b and 118c.

As illustrated in FIG. 11, the circuit includes a pair of linear regulators 120 and 122 connected in parallel for operation of the main LED light 92 (FIGS. 6, 7 and 9), which is attached to connectors 124a and 124b of FIG. 11. While a variety of regulators may be used, an example of a suitable regulator is the model LT3080 linear regulator available from Linear Technology of Milpitas, Calif. When the multi-function switch 72 is configured to illuminate the main LED light, current flows to and from the main LED light through lines 126 and 128, respectively. The current then flows via lines 128 and 132 into regulators 120 and 122 through their respective collector pins. The outputs of the regulators flow from their respective out pins through lines 134 and 136 and through ballast resistors 138a and 138b and back to negative contact 68b. Each regulator 120 and 122 features a V_{control} pin that is the supply pin for the control circuitry for the regulator. Each regulator 120 and 122 also features a Set pin (indicated at 140 and 142 in FIG. 11) which serve as the regulation set points for the regulators. A reference current flows through reference resistor 144 to each regulator Set pin to program a constant output voltage for the regulators. A capacitor 146 is also connected between the Set pin and ground to improve transient performance of the regulators. The parallel regulator configuration is more efficient than a single regulator and allows the generated heat to be spread over a larger area, an important consideration when powering LED lamps.

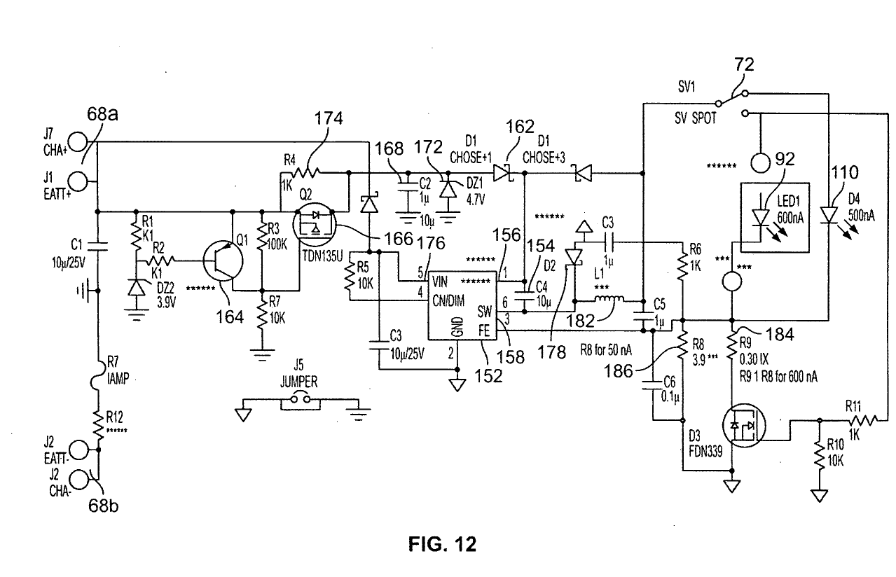

A schematic of an alternative embodiment of the circuitry of the printed circuit board 104 of the control module 66 of FIG. 10 is illustrated in FIG. 12. The embodiment of FIG. 12 provides a smart driver control board that features a multi-input electronic LED driver 152 to provide constant current to the main and backup LEDs 92 and 110, respectively. There is thus no requirement to select voltage input as the electronic LED driver automatically adjusts to provide the correct current level to the LEDs. As a result, when setting up the LED cap lamp for use, the power cord is simply connected to a 3.5-8.5 Volt DC power source. The circuitry of FIG. 12 thus allows the cap lamp to be connected to various manufacturers' batteries without having to make adjustments for varying battery voltages.

The circuitry of FIG. 12 also provides constant current to the main and backup LEDs allowing the light output to remain nearly constant over the discharge time of the battery. The circuitry operates over a larger voltage range than offered by standard current regulators by reconfiguring the inputs to the control circuit at a voltage set point.

With reference to FIG. 12, the LED driver 152 may be, for example, a model LM3405A LED available from National Semiconductor Corporation of Santa Clara, Calif.

A bootstrap boost capacitor 154 is positioned between the V_{boost} and switch pins, 156 and 158 respectively. The bootstrap boost capacitor, along with a boost zener diode 162, are used to generate a voltage V_{boost}. The voltage across capacitor 154, V_{boost}−V_{sw}, is the gate drive voltage to the internal NMOS power switch of the LED driver 152. A pair of transistors 164 and 166 are configured to determine the manner in which V_{boost} is determined. More specifically, current enters the circuit through positive contact 68a. If the battery voltage is greater than or equal to 3.9V, transistors 164 and 166 are both turned off. As a result, a shunt capacitor 168 and shunt zener diode 172 are connected to a resistor 174 so that V_{boost} is derived from Vᵢₙ (pin 176 of LED driver 152) through boost zener diode 162. If the battery voltage is less than 3.9V, transistors 164 and 166 are both turned on. As a result, boost zener diode 162 and zener diode 178 are connected to Vᵢₙ so that V_{boost} is derived from Vᵢₙ through shunt zener diode 172. If the multi-function switch 72 is set to operate the main LED light 92, constant current is provided by the LED driver 152 through the switch pin 158 and inductor 182 and is set by resistor 184. If the multi-function switch 72 is set to operate the backup LED light 110, constant current is provided by the LED driver 152 through the switch pin 158 and inductor 182 and is set by resistor 186.

The LED cap lamp may provide a greater constant light output over a larger range of voltage inputs by utilizing a more efficient high-brightness LED, such as is available from the Phillips Lumileds Lighting Company of San Jose, Calif., under the LUXEON trademark, combined with the integrated heat sink and optic module.

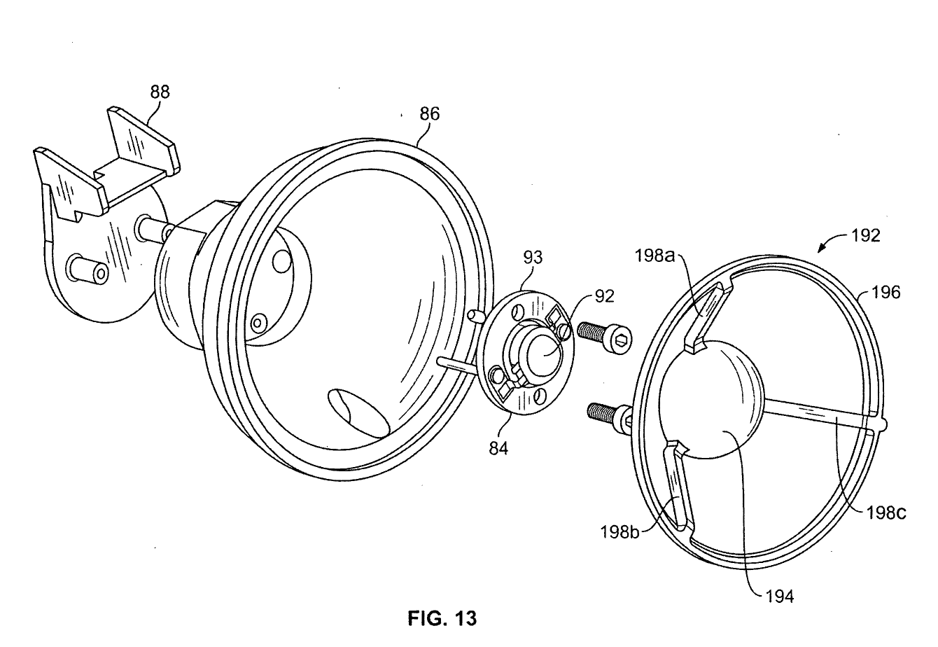

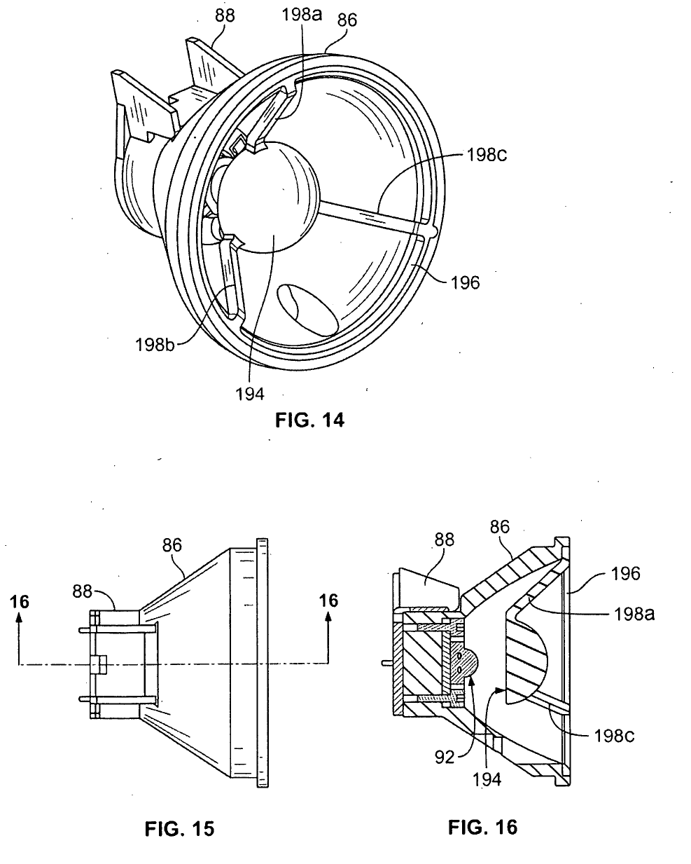

As illustrated in FIGS. 13-16, the optic module may optionally be provided with multiple, interchangeable optic lens, an example of which is indicated in general at 192 in FIG. 13. As illustrated in FIG. 13, the optic lens features a semi-spherical, transparent lens portion 194 that is suspended at the center of a ring 196 by spokes 198a, 198b, and 198c. While various construction techniques may be used, the lens portion 194, ring 196 and spokes 198a-198c are preferably integrally molded from plastic. The length of the spokes dictate the proximity of the lens portion 194 to the main LED light 92. Thus, the selection of the appropriate optic lens 192 can change the light pattern produced by the cap lamp from a spot light to a flood light by varying the distance of the lens 194 from the main LED light 92. Moving the lens 194 away from the main LED light 92, for example, increases the diameter of the light pattern emitted. This allows the user to select the light pattern best suited for their particular job. The optic lens of the cap lamp may be simply changed out by unscrewing and removing bezel 34 (FIG. 5) from the housing 32, removing the existing optic lens and inserting a different optic lens selection. Additional details regarding this feature may be obtained from U.S. Pat. No. 6,986,593 to Rhoads et al.

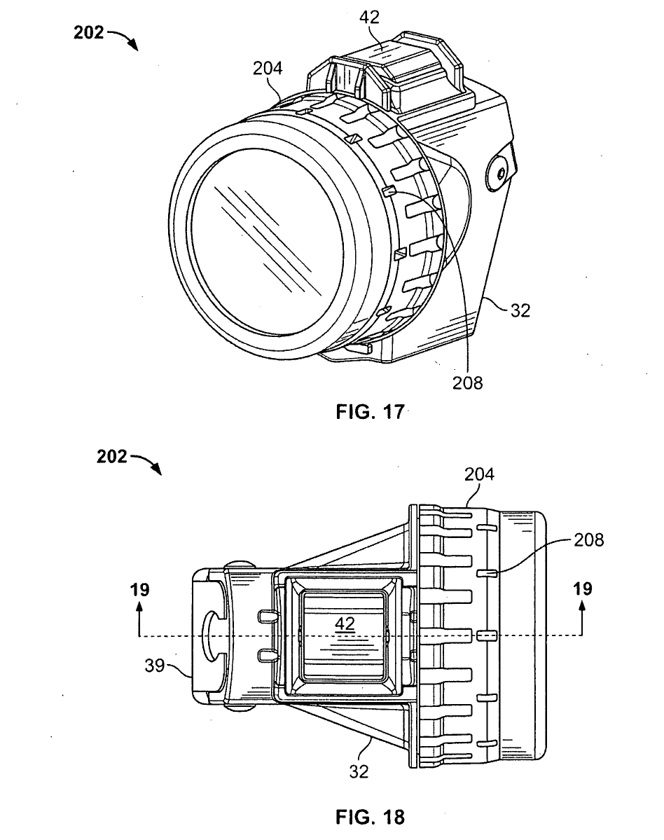

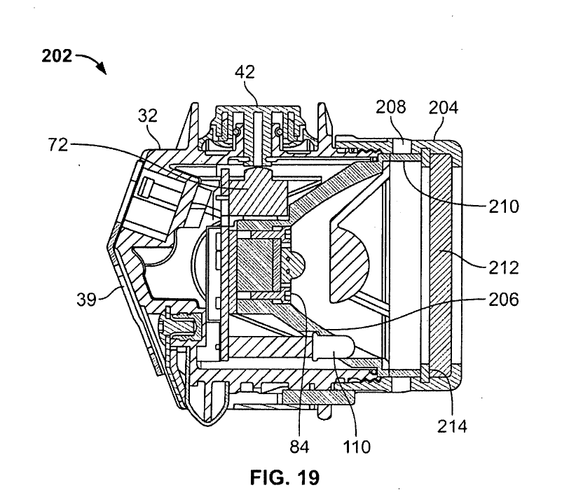

An alternative embodiment of the cap lamp of the present invention is indicated in general at 202 in FIGS. 17-19. This embodiment differs from the embodiment of FIGS. 1-10 solely by the bezel and integrated reflector and heat sink, illustrated at 204 and 206, respectively (the remaining components in FIGS. 17-19 thus retain the same numbering as in FIGS. 1-10). More specifically, the bezel features vent openings 208, which are circumferentially spaced about the bezel. The integrated reflector and heat sink 206 features an extended, annular rim portion, illustrated at 210 in FIG. 19. As illustrated in FIG. 19, the rim portion 210 of the integrated reflector and heat sink 206 extends out from the internal cavity of the cap lamp and is captured by the ventilated (via vent openings 208) bezel, thus exposing it to the surrounding free air. This increases heat dissipation to the atmosphere and improves efficiency of the cap lamp.

Returning to FIG. 5, a lens 212 and gasket 214 are positioned within the bezel 34 to form a bezel assembly. The control module 66 is a single printed circuit board and multi-function switch assembly (as described above) that is loaded through the housing open end (33 in FIG. 5) into the interior cavity defined by the cap lamp housing 32 without tools. The optic module 82 is then inserted into the internal cavity and makes electrical connections with self-aligning electrical components, also without tools or fasteners. To complete assembly of the cap lamp, after the control module 66 and optic module 82 are positioned within the cap lamp housing 32, and the O-ring 64 is positioned over threaded portion 36, the bezel assembly is secured to the cap lamp housing via threads 36 and 38 so that the components/modules are secured and sealed inside the cap lamp housing 32.

The LED cap lamp embodiments of FIGS. 1-19 thus feature a modular design in that all internal components are built as easily assembled modules. The complete internal assembly thus is comprised of two primary modules which are trapped and sealed in the internal cavity of the cap lamp by the bezel assembly. This modular design reduces complexity, speeds assembly and decreases the product's overall size, weight and cost.

While the preferred embodiments of the invention have been shown and described. it will be apparent to those skilled in the art that changes and modifications may be made therein without departing from the spirit of the invention, the scope of which is defined by the appended claims.

What is claimed is:

1. A cap lamp featuring a modular construction comprising:
a) a housing featuring an open end;
b) a control module positioned within the housing, said control module including a switch, a circuit board and contacts adapted to receive power from a battery;
c) an optic module positioned within the housing and in engagement with the control module, said optic module including a main LED light and reflector; and
d) a bezel assembly fastened to the housing so as to cover the open end and secure the control module and optic module within the cap lamp housing.

2. The cap lamp of claim 1 further comprising a clip attached to the cap lamp housing.

3. The cap lamp of claim 1 further comprising recharging contacts in communication with the contacts of the control module.

4. The cap lamp of claim 1 wherein the bezel assembly is fastened to the housing by threads.

5. The cap lamp of claim 4 further comprising an O-ring positioned over a threaded portion of the housing.

6. The cap lamp of claim 1 wherein the bezel assembly includes a lens and an annular gasket.

7. The cap lamp of claim 1 further comprising a pushbutton positioned on the housing, said pushbutton connected to the switch of the control module to permit a user to configure the switch via the pushbutton.

8. The cap lamp of claim 7 wherein the switch is a multi-function switch.

9. The cap lamp of claim 8 further comprising a backup LED positioned within the reflector of the optic module, said backup LED in communication with the multi-function switch so that the main LED light or the backup LED may alternatively be selected.

10. The cap lamp of claim 7 further comprising a diaphragm gasket substantially sealing the periphery of the push button with respect to the cap lamp housing.

11. The cap lamp of claim 10 further comprising a plunger button connecting the pushbutton to the switch.

12. The cap lamp of claim 11 further comprising an inner O-ring positioned around the plunger button.

13. The cap lamp of claim 1 wherein the reflector of the optic module serves as an integrated reflector and heat sink and said optic module further includes an insulator that is positioned between the optic module and the circuit board of the control module.

14. The cap lamp of claim 13 wherein the integrated reflector and heat sink is constructed from aluminum.

15. The cap lamp of claim 1 further comprising a removable optic lens including a semi-spherical transparent lens portion, a ring and a plurality of spokes extending between the ring and lens portion so that the lens portion is positioned generally in the center of the ring, said ring sized to permit the. optic lens to be positioned in the reflector with the lens portion positioned in front of the main LED light in a spaced relation thereto so as to adjust a light pattern produced by the main LED light.

16. A method of constructing a cap lamp including the steps of:
a) providing a housing featuring an open end;
b) providing a control module including a switch, a circuit board and contacts adapted to receive power from a battery;
c) providing an optic module including a main LED light, socket board and reflector;
d) providing a bezel assembly;
e) inserting the control module into the housing through the open end of the housing;
f) inserting the optic module into the housing and into engagement with the control module through the open end of the housing;
g) fastening the bezel assembly to the housing so that the control module and optic module are secured within the cap lamp housing.

17. The method of claim 16 wherein the housing features a threaded portion surrounding the open end and the bezel assembly includes mating threads whereby the bezel assembly may be fastened to the housing.

18. The method of claim 16 wherein the bezel assembly includes a lens and gasket.

19. The method of claim 16 wherein the reflector is an integrated heat sink and reflector and the optic module includes an insulator attached to the back of the integrated heat sink and reflector.

20. The method of claim 19 wherein the integrated heat sink and reflector is constructed from aluminum.

21. A cap lamp comprising:
a) a housing;
b) a switch positioned in the housing and adapted to receive power from a battery;
c) a circuit board in communication with the switch;
d) an integrated reflector and heat sink positioned in the housing, said integrated reflector featuring a central opening;
e) an LED module positioned in the central opening of the integrated reflector and heat sink, said LED module in communication with the circuit board; and
f) an insulator positioned between the integrated reflector and heat sink and the circuit board.

22. The cap lamp of claim 21 wherein the integrated reflector and heat sink is constructed of aluminum.

23. The cap lamp of claim 21 wherein the integrated reflector and heat sink include a recess and further comprising a backup LED positioned in the recess and in communication with the switch.

24. The cap lamp of claim 23 further comprising a standoff connecting the backup LED to the circuit board.

25. The cap lamp of claim 21 wherein the circuit board features a pair of regulators in communication with the switch and connected in parallel to provide current to the LED module.

26. The cap lamp of claim 21 wherein the LED module includes LED leads and the insulator includes a pair of bosses, each having a bore there through and receiving one of the LED leads.

27. The cap lamp of claim 21 wherein the insulator is constructed of thermoplastic.

28. The cap lamp of claim 21 wherein the housing features an open end and further comprising a bezel fastened over the open end of the housing.

29. The cap lamp of claim 28 wherein the bezel includes a plurality of circumferentially-spaced vent openings so that a portion of the integrated reflector and heat sink may be exposed to ambient air for cooling.

30. The cap lamp of claim 29 wherein the integrated reflector and heat sink includes an extended annular rim portion positioned adjacent to the plurality of vent openings.

31. A cap lamp comprising:
a) a housing;
b) a switch positioned in the housing and adapted to receive power from a battery;
c) a circuit board in communication with the switch;
d) an reflector positioned in the housing, said reflector featuring a central opening;
e) an LED module positioned in the central opening of the reflector and in communication with the circuit board; and
f) said circuit board featuring a pair of regulators in communication with the switch and connected in parallel to provide current to the LED module.

32. The cap lamp of claim 31 wherein the switch is a multi-function switch.

33. The cap lamp of claim 32 further comprising a backup LED positioned within the reflector of the optic module, said backup LED in communication with the multi-function switch so that a main LED light of the LED module or the backup LED may alternatively be selected.

34. The cap lamp of claim 33 wherein the backup LED is attached to the circuit board by a standoff.

35. The cap lamp of claim 33 wherein the standoff is constructed of plastic.

36. The cap lamp of claim 32 wherein the reflector includes a recess and the backup LED is positioned within the recess.

37. The cap lamp of claim 31 wherein each regulator includes a set pin and wherein the circuit board includes a reference resistor in communication with the set pin.

38. The cap lamp of claim 37 further comprising a capacitor positioned in parallel with the reference resistor and also in communication with the set pin.

39. The cap lamp of claim 31 wherein the reflector is an integrated reflector and heat sink.

40. The cap lamp of claim 39 wherein the integrated reflector and heat sink is constructed from aluminum.

41. The cap lamp of claim 39 wherein the housing features an open end and further comprising a bezel fastened over the open end of the housing.

42. The cap lamp of claim 41 wherein the bezel includes a plurality of circumferentially-spaced vent openings so that a portion of the integrated reflector and heat sink may be exposed to ambient air for cooling.

43. The cap lamp of claim 42 wherein the integrated reflector and heat sink includes an extended annular rim portion positioned adjacent to the plurality of vent openings.

44. A cap lamp comprising:
a) a housing;
b) a multi-function switch positioned in the housing and adapted to receive power from a battery;
c) an reflector positioned in the housing, said reflector featuring a central opening;
d) a main LED light positioned in the central opening of the reflector and in communication with the multi-function switch; and
e) a backup LED positioned in the reflector and in communication with the multi-function switch.

45. The cap lamp of claim 44 wherein the reflector includes a recess and the backup LED is positioned within the recess.

46. The cap lamp of claim 44 wherein the backup LED communicates with the multi-function switch through the circuit board.

47. The cap lamp of claim 46 further comprising a standoff by which the backup LED is mounted to the circuit board.

48. The cap lamp of claim 44 further comprising a pushbutton positioned on the housing, said pushbutton connected to the multi-function switch to permit a user to configure the switch via the pushbutton.

49. A cap lamp comprising:
a) a housing;
b) a switch positioned in the housing and adapted to receive power from a battery;
c) a circuit board in communication with the switch;
d) an reflector positioned in the housing, said reflector featuring a central opening;
e) an LED module positioned in the central opening of the reflector and in communication with the circuit board; and
f) said circuit board featuring circuitry whereby a constant current is provided to the LED module over a range of voltage values of the battery.

50. The cap lamp of claim 49 wherein the circuitry includes an LED driver.

51. The cap lamp of claim 50 wherein the circuitry includes at least one transistor the controls the configuration of the LED driver.

52. The cap lamp of claim 49 wherein the LED module includes a main LED light.

53. The cap lamp of claim 52 further comprising a backup LED positioned within the reflector and also in communication with the circuit board.

54. The cap lamp of claim 53 wherein the switch is a multi-function switch whereby a user may select between the backup LED and the main LED light of the LED module.

55. The cap lamp of claim 49 wherein the circuit board includes contacts which are adapted to connect the switch to the battery.
